(19) United States
(12) Patent Application Publication
(10) Pub. No.: US 2026/0011948 A1
(43) Pub. Date: Jan. 8, 2026

(54) CONNECTOR AND HOUSING

(71) Applicant: Bellwether Electronic Corp., Taoyuan City (TW)

(72) Inventors: Hsing-Yu LEE, Taoyuan City (TW); Ching-Hsiang CHANG, Taoyuan City (TW)

(21) Appl. No.: 19/241,416

(22) Filed: Jun. 18, 2025

Related U.S. Application Data
(60) Provisional application No. 63/667,816, filed on Jul. 5, 2024.
(60) Provisional application No. 63/692,187, filed on Sep. 9, 2024.

(51) Int. Cl. H01R 13/502; H01R 13/22; H01R 13/627; H01R 13/639; H01R 13/652

(52) U.S. Cl. CPC H01R 13/502; H01R 13/22; H01R 13/6273; H01R 13/652; H01R 13/639

(57) ABSTRACT

A connector includes a housing, a first conductive terminal set, and a second conductive terminal set. The housing includes a bottom portion, two upright portions, two wing portions, a limiting portion, an extending portion, and a latch. The two upright portions extend in parallel from the bottom portion. The two upright portions jointly define a trench. The extending portion extends from a side surface of the bottom portion and is connected to one of the two wing portions. The extending portion has a latch channel. The wing portion has a through hole and communicates with the latch channel. A latch is slidably accommodated in the latch channel and is configured to partially pass through the through hole. The first conductive terminal set and the second conductive terminal set are accommodated in an accommodating space of the housing and respectively extend adjacent to the two upright portions.

### CROSS-REFERENCE TO RELATED APPLICATION

This application claims priority to U.S. Provisional Application Ser. No. 63/667,816, filed Jul. 5, 2024, and U.S. Provisional Application Ser. No. 63/692,187, filed Sep. 9, 2024, which are herein incorporated by reference in their entireties.

### BACKGROUND

### Field of Invention

The present invention relates to a connector and a housing.

### Description of Related Art

In general, whether between a cable and a circuit board or between a cable and a busbar, electrical connection is achieved through a connector.

However, as the overall current demand of systems increases, both the number of conductive terminals in connectors and the physical size of the connectors increase accordingly. Different system configurations require different levels of current. Since the specifications of busbar connectors are often fixed (i.e., the rated current specification is fixed), the need to accommodate various current requirements has led to an increase in the variety of connectors. This, in turn, results in increased production and inventory costs.

Therefore, how to propose a connector and a housing that can solve the aforementioned problems is one of the problems that the industry is currently eager to invest in research and development resources to solve.

### SUMMARY

In view of this, one purpose of the present disclosure is to provide a connector and a housing that can solve the aforementioned problems.

In order to achieve the above objective, in accordance with an embodiment of the present disclosure, a connector includes a housing, a first conductive terminal set, and a second conductive terminal set. The housing includes a bottom portion, two upright portions, two wing portions, a limiting portion, an extending portion, and a latch. The bottom portion has an accommodating space. The two upright portions extend in parallel from the bottom portion in an extending direction. The two upright portions jointly define a trench. The two wing portions respectively extend away from each other in a direction away from the two upright portions. The two wing portions extend beyond a side surface of the bottom portion. The limiting portion is disposed on one of the two upright portions and separated from the two wing portions. The extending portion extends from a side surface of the bottom portion and connected to one of the two wing portions. The extending portion has a latch channel. The one of the two wing portions has a through hole communicating with the latch channel. The latch is slidably accommodated in the latch channel and configured to partially pass through the through hole. The first conductive terminal set and the second conductive terminal set are accommodated in the accommodating space of the housing and respectively extend adjacent to the two upright portions.

In one or more embodiments of the present disclosure, each of the first conductive terminal set and the second conductive terminal set includes a first conductive terminal, a second conductive terminal, and a fixing portion. The first conductive terminal and the second conductive terminal are sequentially arranged in a direction and each include a middle portion and a plurality of contacting portions. The contacting portions extend from an end of the middle portion into the trench. The fixing portion secures the middle portion of the first conductive terminal and the middle portion of the second conductive terminal.

In one or more embodiments of the present disclosure, the contacting portions of the first conductive terminal and the contacting portions of the second conductive terminal are alternately arranged in a direction.

In one or more embodiments of the present disclosure, each of the first conductive terminal set and the second conductive terminal set further includes a third conductive terminal. The third conductive terminal of the first conductive terminal set includes a first protruding portion protruding outward from the accommodating space. The third conductive terminal of the second conductive terminal set includes a second protruding portion protruding outward from the accommodating space. The first protruding portion and the second protruding portion are plate-shaped and extend in parallel. A length of the first protruding portion is less than a length of the second protruding portion.

In one or more embodiments of the present disclosure, the bottom portion further includes a plurality of gaps located on the side surface of the bottom portion. The first protruding portion and the second protruding portion respectively pass through the gaps.

In one or more embodiments of the present disclosure, the connector further includes a cover body covering a side of the bottom portion away from the two upright portions. The cover body includes a plurality of supporting ribs and a slit defined between the supporting ribs. A portion of the third conductive terminal is accommodated in the slit. The first conductive terminal abuts against the supporting ribs.

In one or more embodiments of the present disclosure, each of the first conductive terminal set and the second conductive terminal set further includes a third conductive terminal. The third conductive terminal of the first conductive terminal set includes a first protruding portion and a second protruding portion protruding outward from the accommodating space and extending away from each other. The third conductive terminal of the second conductive terminal set includes a third protruding portion and a fourth protruding portion protruding outward from the accommodating space and extending away from each other. The first protruding portion and the third protruding portion are plate-shaped and extend in parallel. The second protruding portion and the fourth protruding portion are plate-shaped and extend in parallel.

In one or more embodiments of the present disclosure, both the first protruding portion and the second protruding portion and both the third protruding portion and the fourth protruding portion are respectively located on opposite sides of the accommodating space.

In one or more embodiments of the present disclosure, the connector further includes two ground terminals. One of the two ground terminals has a perforation. The perforation is aligned with the through hole of the two wing portions.

In one or more embodiments of the present disclosure, the other one of the two wing portions includes a blocking portion on a surface close to the two upright portions. The blocking portion extends along the extending direction.

In one or more embodiments of the present disclosure, the latch further includes a first elastic arm, a second elastic arm, a first hook, a second hook, and a bump. The first elastic arm has a fixed end connected to a bottom end of the latch and a free end. The second elastic arm has a fixed end connected to a top end of the latch and a free end. The first elastic arm and the second elastic arm are located on opposite sides of the latch. The first hook and the second hook are respectively disposed on the free end of the first elastic arm and the free end of the second elastic arm. The bump is disposed on the first elastic arm.

In one or more embodiments of the present disclosure, the extending portion further has a status hole communicating with the latch channel. The bump passes through the status hole and is movable relative to the status hole.

In order to achieve the above objective, in accordance with an embodiment of the present disclosure, a housing includes a bottom portion, two upright portions, two wing portions, a limiting portion, an extending portion, and a latch. The bottom portion has an accommodating space. The two upright portions extend in parallel from the bottom portion in an extending direction. The two upright portions jointly define a trench. The two wing portions respectively extend away from each other in a direction away from the two upright portions. The two wing portions extend beyond a side surface of the bottom portion. The limiting portion is disposed on one of the two upright portions and separated from the two wing portions. The extending portion extends from the side surface of the bottom portion. The extending portion is connected to one of the two wing portions. The extending portion has a latch channel. The one of the two wing portions has a through hole communicating with the latch channel. The latch is slidably accommodated in the latch channel and configured to partially pass through the through hole.

In one or more embodiments of the present disclosure, the bottom portion further includes a plurality of gaps located on the side surface of the bottom portion.

In one or more embodiments of the present disclosure, the housing further includes a cover body covering a side of the bottom portion away from the two upright portions. The cover body includes a plurality of supporting ribs and a slit defined between the supporting ribs.

In one or more embodiments of the present disclosure, the other one of the two wing portions comprises a blocking portion on a surface close to the two upright portions, and the blocking portion extends along the extending direction.

In one or more embodiments of the present disclosure, the latch further includes a first elastic arm, a second elastic arm, a first hook, a second hook, and a bump. The first elastic arm has a fixed end connected to a bottom end of the latch and a free end. The second elastic arm has a fixed end connected to a top end of the latch and a free end. The first elastic arm and the second elastic arm are located on opposite sides of the latch. The first hook and the second hook are respectively disposed on the free end of the first elastic arm and the free end of the second elastic arm. The bump is disposed on the first elastic arm.

In one or more embodiments of the present disclosure, the extending portion further has a status hole communicating with the latch channel. The bump passes through the status hole and is movable relative to the status hole.

In one or more embodiments of the present disclosure, the bottom portion further includes a plurality of partitioning walls. The partitioning walls are interlaced in the accommodating space and divide the accommodating space into two conductive terminal channels and two signal terminal channels. The partitioning walls communicate with the trench.

In one or more embodiments of the present disclosure, the limiting portion and the one of the two wing portions are separated by a distance.

In summary, in the connector and the housing of the present disclosure, since each of the first conductive terminal set and the second conductive terminal set includes a locking beam abutting against a blocking surface, the first conductive terminal set and the second conductive terminal set can be positioned on the housing when assembled into the housing. In the connector and the housing of the present disclosure, since the conductive terminal includes a crimping portion bent along a rotation axis, the crimping portion of the conductive terminal can tightly bind the cable, thereby ensuring that the cable is in reliable contact with the conductive terminal. In the connector and the housing of the present disclosure, since the locking part of each of the first conductive terminal set and the second conductive terminal set includes a raised portion protruding from a middle portion, when the first conductive terminal set and the second conductive terminal set are assembled into the housing, the first conductive terminal set and the second conductive terminal set can be separated from the two upright portions of the housing by a distance to form a void, thereby enhancing the heat dissipation efficiency of the connector. In the connector and the housing of the present disclosure, since the connector includes a panel disposed on the housing, the panel has a hollowed portion through which the two upright portions pass, and the connector further includes a latch passing through a wing portion and a blocking portion disposed on the wing portion, the housing can be appropriately limited in the lateral direction relative to the panel, thereby preventing the housing from detaching from the panel. In the connector and the housing of the present disclosure, since the panel covers the latch and the perforation of the ground terminal when the limiting portion is aligned with the first indentation, and the latch is exposed relative to the third indentation when the limiting portion is staggered from the first indentation, the housing can enter the hollowed portion of the panel, and the housing can be appropriately limited in the longitudinal direction relative to the panel through the special structure of the panel, thereby preventing the housing from detaching from the panel. In the connector and the housing of the present disclosure, since the first connecting plate and the second connecting plate pass through the opening, and the portion of the first connecting plate and the portion of the second connecting plate extending beyond of the bottom portion of the housing spaced by a distance (i.e., staggered), a place where the cable and the portion of the first connecting plate connect and a place where the cable and the portion of the second connecting plate connect can be staggered, thereby reducing spatial interference between cables and saving occupied space. Overall, the connector and the housing of the present disclosure provides structural stability to the overall connector.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a perspective view of a connector in accordance with an embodiment of the present disclosure;

FIG. 2 is a perspective view of the connector in accordance with an embodiment of the present disclosure;

FIG. 3 is an exploded view of the connector in accordance with an embodiment of the present disclosure;

FIG. 4 is a cross-sectional view of the connector in accordance with an embodiment of the present disclosure;

FIG. 5 is a perspective view of a connector in accordance with an embodiment of the present disclosure;

FIG. 6 is a bottom view of the connector in accordance with an embodiment of the present disclosure;

FIG. 7 is an exploded view of the connector in accordance with an embodiment of the present disclosure;

FIG. 8 is a cross-sectional view of the connector in accordance with an embodiment of the present disclosure;

FIG. 9 is a perspective view of a connector in accordance with an embodiment of the present disclosure;

FIG. 10 is a bottom view of the connector in accordance with an embodiment of the present disclosure;

FIG. 11 is a perspective view of a connector in accordance with an embodiment of the present disclosure;

FIG. 12 is an exploded view of the connector in accordance with an embodiment of the present disclosure;

FIG. 13 is a perspective view of the connector in a first state in accordance with an embodiment of the present disclosure;

FIG. 14 is a top view of the connector in the first state in accordance with an embodiment of the present disclosure;

FIG. 15 is a sided view of the connector in the first state in accordance with an embodiment of the present disclosure;

FIG. 16 is a perspective view of the connector in a second state in accordance with an embodiment of the present disclosure;

FIG. 17 is a top view of the connector in the second state in accordance with an embodiment of the present disclosure;

FIG. 18 is a sided view of the connector in the second state in accordance with an embodiment of the present disclosure;

FIG. 19 is a perspective view of the connector in a third state in accordance with an embodiment of the present disclosure;

FIG. 20 is a top view of the connector in the third state in accordance with an embodiment of the present disclosure;

FIG. 21 is a sided view of the connector in the third state in accordance with an embodiment of the present disclosure;

FIG. 22 is a perspective view of a connector in accordance with an embodiment of the present disclosure;

FIG. 23 is an exploded view of the connector in accordance with an embodiment of the present disclosure; and

FIG. 24 is a cross-sectional view of the connector in accordance with an embodiment of the present disclosure.

### DETAILED DESCRIPTION

Hereinafter, a plurality of embodiments of the present disclosure will be disclosed in diagrams. For the sake of clarity, many details in practice will be described in the following description. However, it should be understood that these details in practice should not limit present disclosure. In other words, in some embodiments of present disclosure, these details in practice are unnecessary. In addition, for simplicity of the drawings, some conventionally used structures and elements will be shown in a simple schematic manner in the drawings. The same reference numbers are used in the drawings and the description to refer to the same or like parts.

Hereinafter, the structure, function, and connection relationships of each component included in a connector 100 of this embodiment will be described in detail.

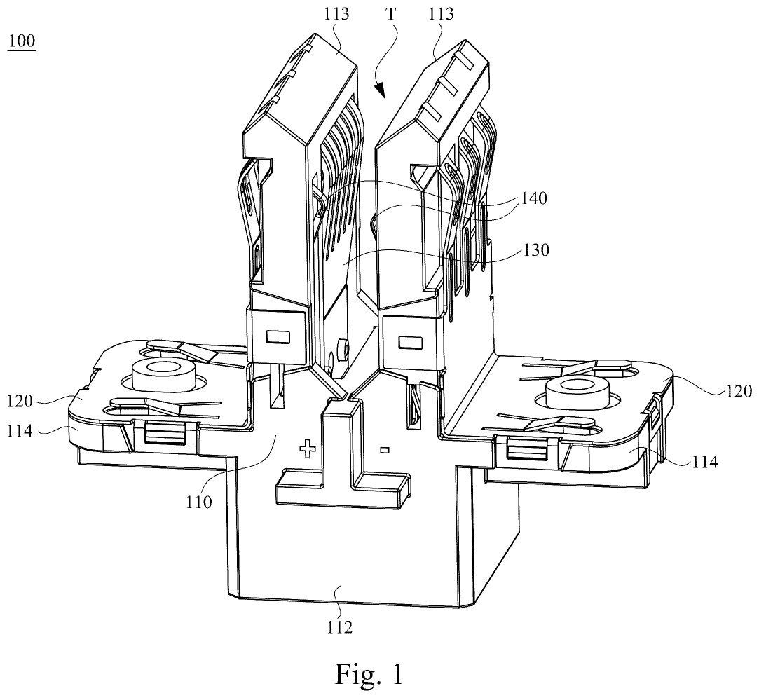

Reference is made to FIG. 1. FIG. 1 is a perspective view of a connector 100 in accordance with an embodiment of the present disclosure. As shown in FIG. 1, in this embodiment, the connector 100 includes a housing 110, a first conductive terminal set, and a second conductive terminal set. The first conductive terminal set and the second conductive terminal set respectively include a conductive terminal 130. The connector 100 further includes two ground terminals 120 and two signal terminals 140. The housing 110 includes a bottom portion 112, two upright portions 113, and two wing portions 114. The two upright portions 113 extend in parallel from the bottom portion 112. Specifically, the two upright portions 113 extend in parallel with each other along a longitudinal direction. The two upright portions 113 jointly define a trench T. The two wing portions 114 are respectively connected between the bottom portion 112 and the corresponding upright portion 113. The two wing portions 114 extend away from each other and are perpendicular to the upright portions 113. The wing portion 114 is connected between the bottom portion 112 and the upright portion 113. The two wing portions 114 extend beyond a side surface of the bottom portion 112. The two ground terminals 120 are L-shaped and are respectively engaged with the corresponding two upright portions 113 and the two wing portions 114.

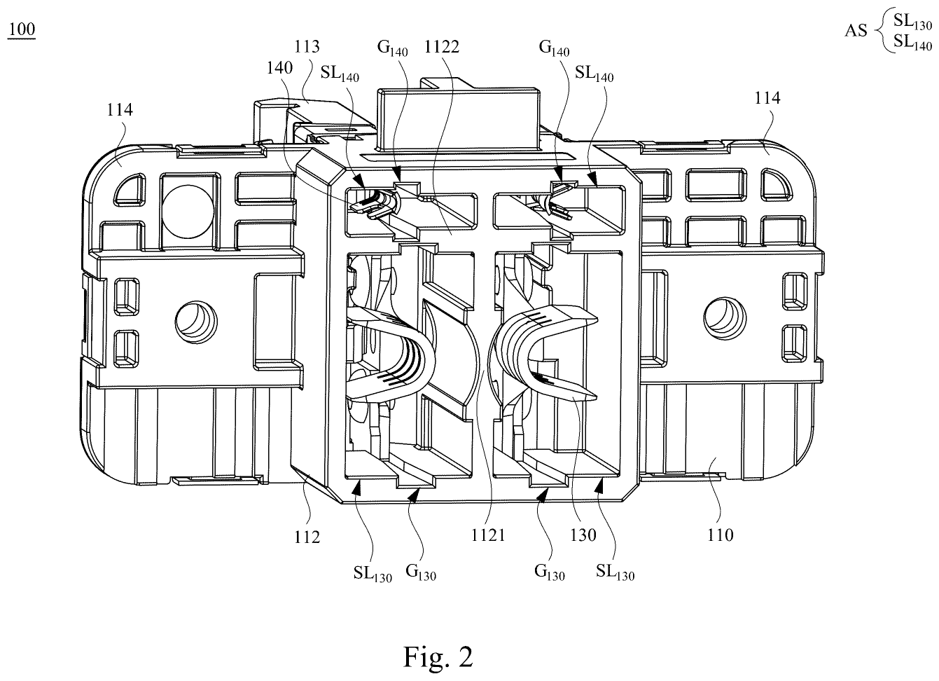

Reference is made to FIG. 2. FIG. 2 is a perspective view of the connector 100 in accordance with an embodiment of the present disclosure. The bottom portion 112 of the housing 110 includes an accommodating space AS. The first conductive terminal set and the second conductive terminal set are accommodated in the accommodating space AS and respectively extend adjacent to the two upright portions 113. Specifically, the bottom portion 112 includes a partitioning wall 1121 and a partitioning wall 1122. The partitioning wall 1121 and the partitioning wall 1122 are interlaced in the accommodating space AS and divide the accommodating space AS into two conductive terminal channels SL₁₃₀ and two signal terminal channels SL₁₄₀, and both the partitioning wall 1121 and the partitioning wall 1122 communicate with the trench T. The conductive terminal 130 is accommodated in the conductive terminal channel SL₁₃₀, and the signal terminal 140 is accommodated in the signal terminal channel SL₁₄₀. The bottom portion 112 further has a guiding groove G₁₃₀ and a guiding groove G₁₄₀. The guiding groove G₁₃₀ is recessed from an edge of the conductive terminal channel SL₁₃₀ and configured to guide the movement of the conductive terminal 130 within the conductive terminal channel SL₁₃₀. The guiding groove G₁₄₀ is recessed from an edge of the signal terminal channel SL₁₄₀ and configured to guide the movement of the signal terminal 140 within the signal terminal channel SL₁₄₀.

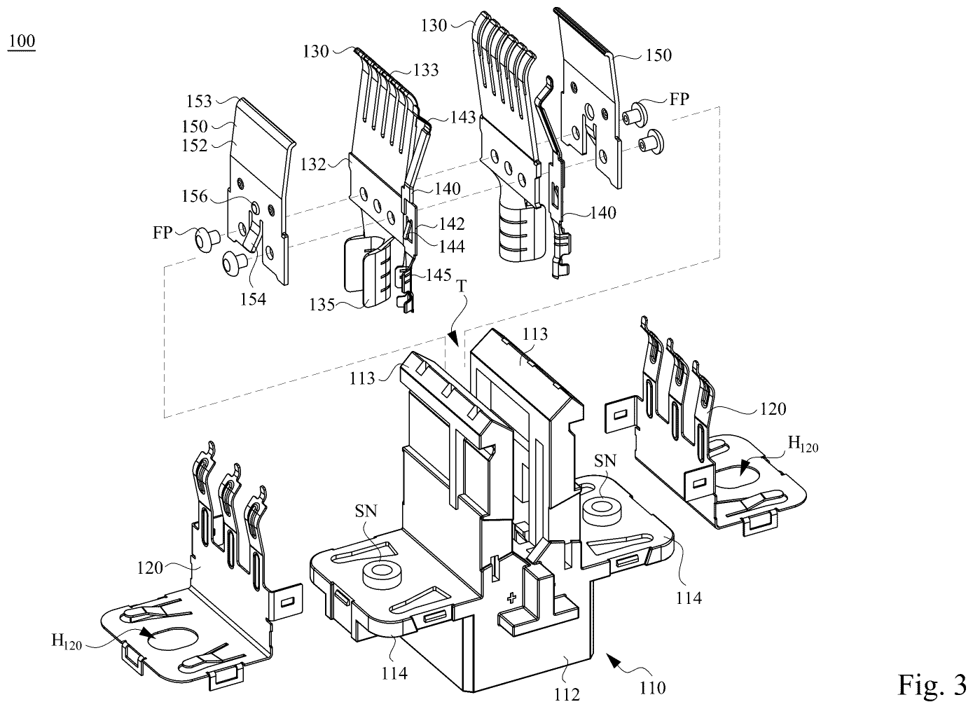

Reference is made to FIG. 3. FIG. 3 is an exploded view of the connector 100 in accordance with an embodiment of the present disclosure. The connector 100 further includes a locking part 150 and a fixing portion FP. The fixing portion FP is configured to secure the conductive terminal 130 and the locking part 150. Each of the two wing portions 114 includes a convex ring SN. Each ground terminal 120 has a perforation H₁₂₀. The convex ring SN passes through the perforation H₁₂₀. The conductive terminal 130 includes a middle portion 132, a plurality of contacting portions 133, and a crimping portion 135. The contacting portions 133 extend from an end of the middle portion 132 into and are exposed within the trench T. The crimping portion 135 extends from the other end of the middle portion 132 and is used to crimp a cable (not shown). The signal terminal 140 is separated from the conductive terminal 130 by the partitioning wall 1122. The signal terminal 140 includes a middle portion 142, a contacting portion 143, a locking beam 144, and a crimping portion 145. The contacting portion 143 extends from an end of the middle portion 142 into and is exposed within the trench T. The locking beam 144 extends outward from the middle portion 142 to form a free end, and forms an acute angle with an extending direction of the middle portion 142. The locking beam 144 is configured to abut against an inner surface of the housing 110 so that the signal terminal 140 is limited within the housing 110. The crimping portion 145 extends from the other end of the middle portion 142 and is used to crimp a cable (not shown).

The locking part 150 includes a middle portion 152, a supporting portion 153, a locking beam 154, and a raised portion 156. The middle portion 152 is connected to the middle portion 132 of the conductive terminal 130 via the fixing portion FP. The supporting portion 153 is connected to an end of the middle portion 152 and inclined toward the conductive terminal 130. The locking beam 154 extends outward from the middle portion 152 to form a free end and forms an acute angle with an extending direction of the middle portion 152. The locking beam 154 is configured to abut against an inner surface of the housing 110 so that the conductive terminal 130 and the locking part 150 are limited within the housing 110. In some embodiments, the locking beam 154 is located at an edge of the middle portion 152. The raised portion 156 of the locking part 150 protrudes outward (i.e., away from the conductive terminal 130) from the middle portion 152 of the locking part 150.

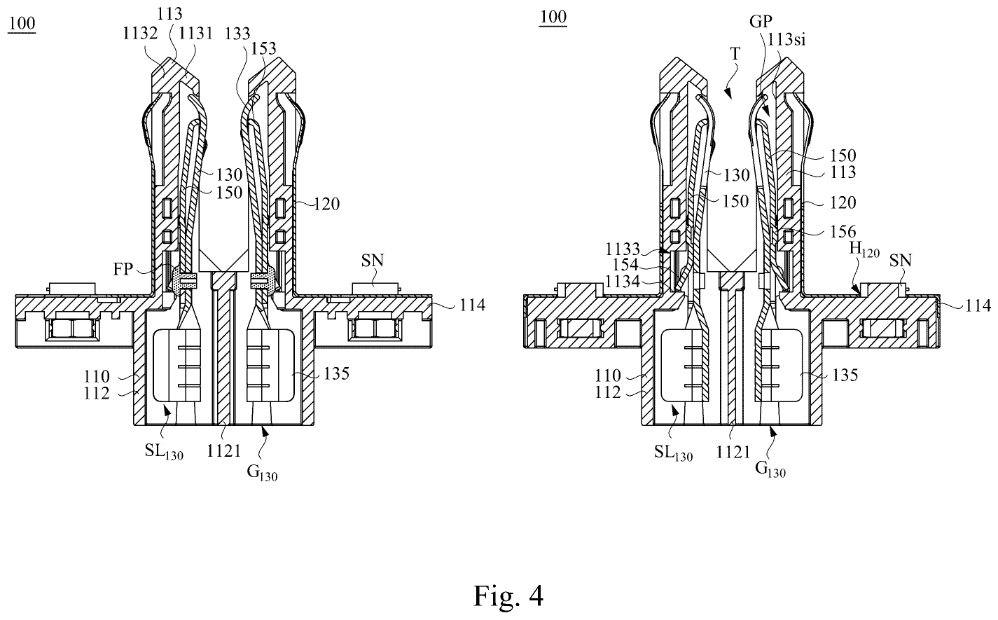

Reference is made to FIG. 4. FIG. 4 is a cross-sectional view of the connector 100 in accordance with an embodiment of the present disclosure. An end of each upright portion 113 of the connector 100 that is remote from the bottom portion 112 includes an inner eaves 1131 and an outer eaves 1132. The inner eaves 1131 extends toward the trench T (i.e., an inner side of the upright portion 113) and defines an inner recessed space. The outer eaves 1132 extends away from the trench T (i.e., an outer side of the upright portion 113). A front end of the contacting portion 133 of the conductive terminal 130 enters the inner recessed space of the inner eaves 1131. An end of the ground terminal 120 abuts against the outer eaves 1132 so that the outer eaves 1132 blocks the ground terminal 120 from moving in the longitudinal direction. A height of the supporting portion 153 is lower than a height of the contacting portion 133, and an end of the contacting portion 133 is located directly under the inner eaves 1131, such that the inner eaves 1131 blocks the conductive terminal 130 and the locking part 150. The raised portion 156 of the locking part 150 abuts against the inner surface 113si of the upright portion 113, so that a void GP is formed between the locking part 150 and the upright portion 113 for airflow. The inner surfaces 113si of the two upright portions 113 respectively have a recessed portion 1133 and form a blocking surface 1134 such that the free end of the locking beam 154 abuts thereagainst to achieve a limiting function.

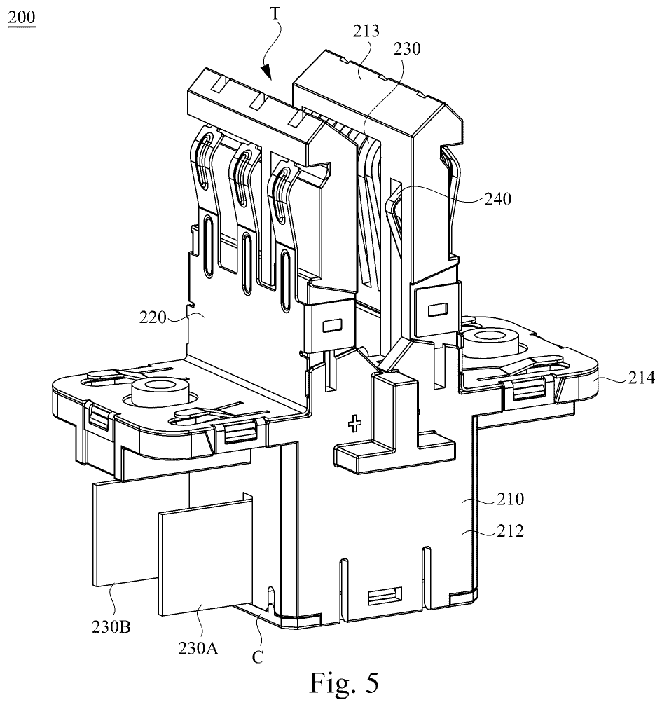

Reference is made to FIG. 5. FIG. 5 is a perspective view of a connector 200 in accordance with an embodiment of the present disclosure. The connector 200 includes a housing 210, two ground terminals 220, and two first conductive terminals 230. Compared with the embodiment shown in FIG. 1, which is a vertical-exit connector, this embodiment is a side-exit connector. The differences between the two embodiments will be described below. For the same structures, reference is made to the description of the previous embodiment. A connecting portion 230A and a connecting portion 230B extend from a side of the housing 210 and are configured to be electrically connected to cables, busbars, or other conductive components. A cover body C covers a side of a bottom portion 212 of the housing 210 away from the two upright portions 213.

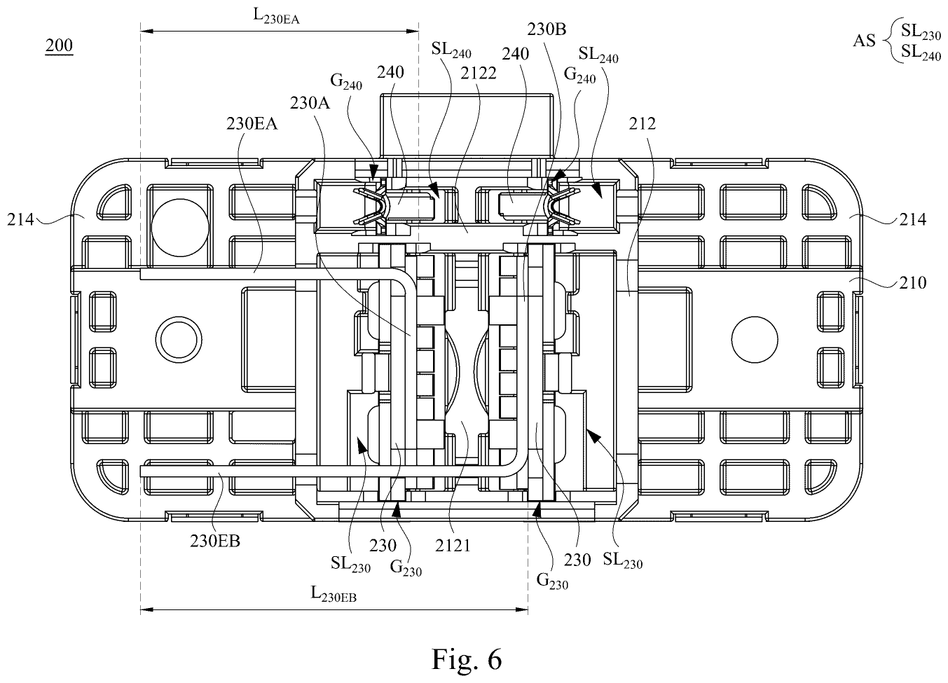

Reference is made to FIG. 6. FIG. 6 is a bottom view of the connector 200 in accordance with an embodiment of the present disclosure. A partitioning wall 2121 and a partitioning wall 2122 are interlaced in the accommodating space AS and divide the accommodating space AS into two conductive terminal channels SL₂₃₀ and two signal terminal channels SL₂₄₀. The partitioning wall 2121 and the partitioning wall 2122 communicate with the trench T. A guiding groove G₂₃₀ is recessed from an edge of the conductive terminal channel SL₂₃₀ and configured to guide movement of the first conductive terminal 230 within the conductive terminal channel SL₂₃₀. A guiding groove G₂₄₀ is recessed from an edge of the signal terminal channel SL₂₄₀ and configured to guide movement of the signal terminal 240 within the signal terminal channel SL₂₄₀. The connecting portion 230A and the connecting portion 230B respectively include a protruding portion 230EA and a protruding portion 230EB. The protruding portion 230EA and the protruding portion 230EB are plate-shaped and protrude outward from the accommodating space AS beyond the same side of the bottom portion 212. The protruding portion 230EA and the protruding portion 230EB extend in parallel and are perpendicular to the wing portion 214. In some embodiments, a length L_{230EA} of the protruding portion 230EA is less than a length L_{230EB} of the protruding portion 230EB, such that both protruding portions extend the same distance beyond the side edge of the bottom portion 212.

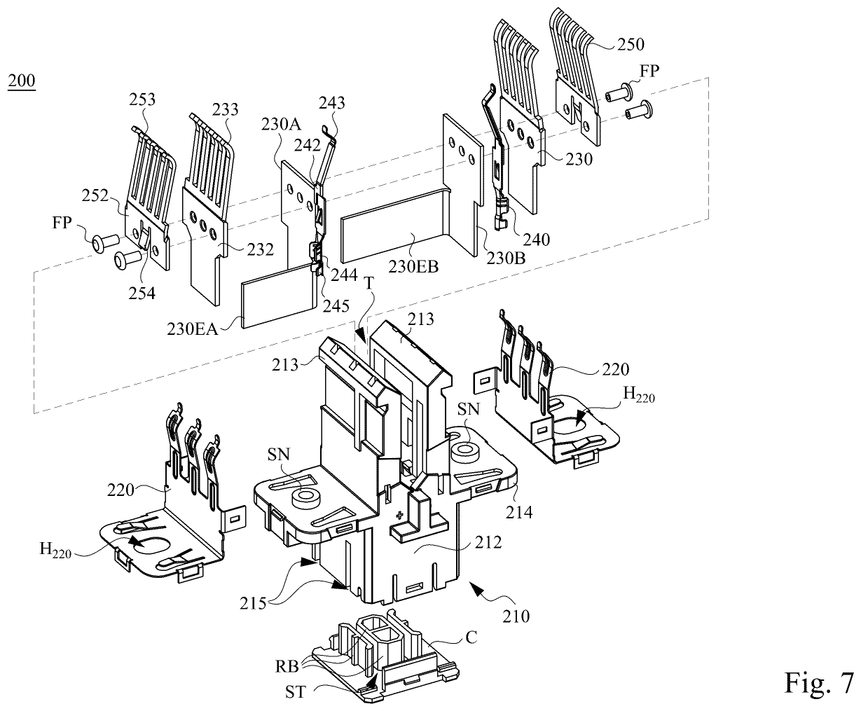

Reference is made to FIG. 7. FIG. 7 is an exploded view of the connector 200 in accordance with an embodiment of the present disclosure. The first conductive terminal 230 includes a middle portion 232 and a plurality of contacting portions 233. The contacting portions 233 extend from an end of the middle portion 232. The signal terminal 240 includes a middle portion 242, a contacting portion 243, a locking beam 244, and a crimping portion 245. The second conductive terminal 250 includes a middle portion 252, a plurality of contacting portions 253, and a locking beam 254. The contacting portions 253 extend from an end of the middle portion 252. A plurality of gaps 215 is formed on a side surface of the bottom portion 212. The protruding portion 230EA and the protruding portion 230EB of the connecting portion 230A and the connecting portion 230B respectively pass through one of the gaps 215. A fixing portion FP passes through and secures the middle portion 232 of the first conductive terminal 230, the middle portion 252 of the second conductive terminal 250, and the connecting portion 230A. Each of the two ground terminals 220 has a perforation H₂₂₀. The cover body C includes a plurality of supporting ribs RB and has a slit ST. The supporting ribs RB protrude toward the accommodating space AS of the bottom portion 212. The slit ST is defined between the plurality of supporting ribs RB.

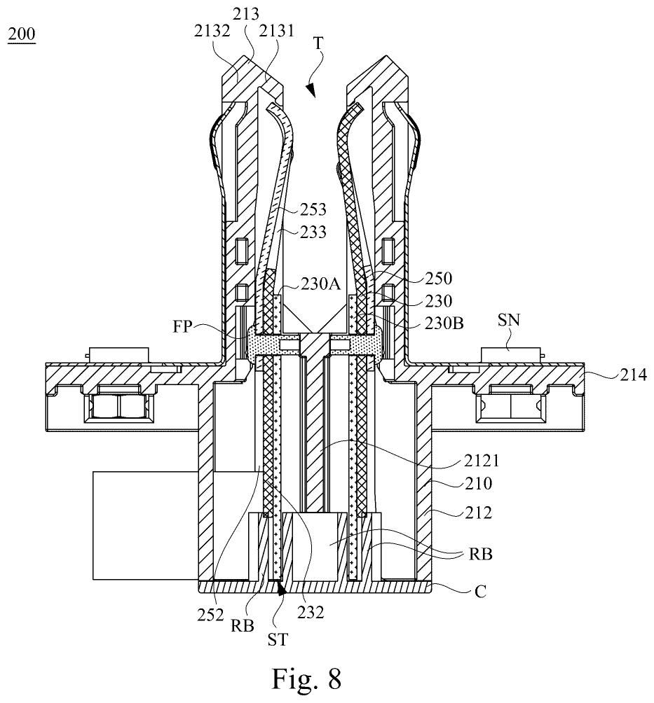

Reference is made to FIG. 8. FIG. 8 is a cross-sectional view of the connector 200 in accordance with an embodiment of the present disclosure. As shown in FIG. 7 and FIG. 8, the plurality of contacting portions 233 of the first conductive terminal 230 and the plurality of contacting portions 253 of the second conductive terminal 250 are alternately arranged in a direction (e.g., a direction perpendicular to the surface of the paper). A portion of the contacting portion 233 of the first conductive terminal 230 and a portion of the contacting portion 253 of the second conductive terminal 250 are overlapped in the aforementioned direction (e.g., a direction perpendicular to the surface of the paper). The first conductive terminal 230 abuts against the supporting ribs RB of the cover body C. The portion of the connecting portion 230A and the portion of the connecting portion 230B are both located in the slit ST.

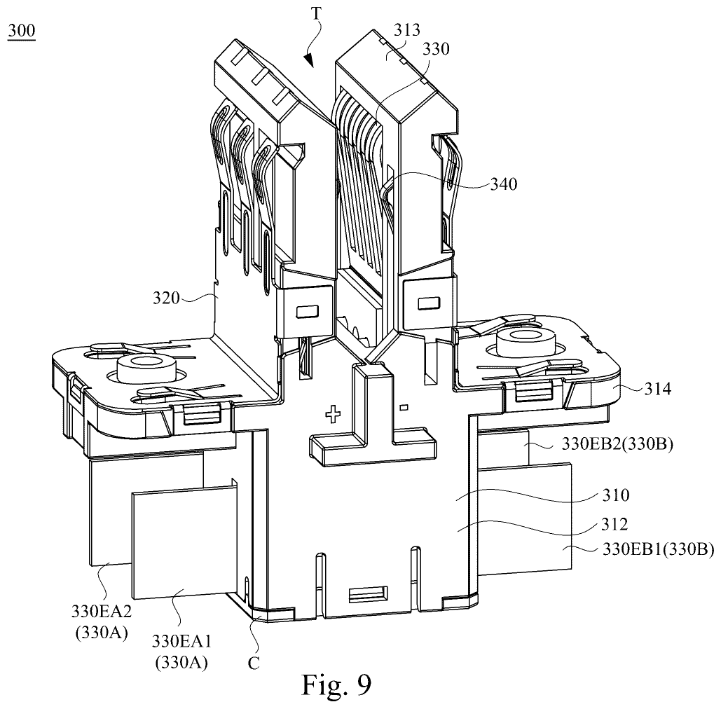

Reference is made to FIG. 9. FIG. 9 is a perspective view of a connector 300 in accordance with an embodiment of the present disclosure. Compared with the previously described embodiments, the connector 300 is a dual-side-exit connector. The connector 300 includes a housing 310, a ground terminal 320, two first conductive terminals 330, and a signal terminal 340. The housing 310 includes a bottom portion 312, two upright portions 313, and two wing portions 314. One of the two first conductive terminals 330 includes a connecting portion 330A, and the other one of the two first conductive terminals 330 includes a connecting portion 330B. The following description focuses only on the differences of this embodiment. The remaining structures are the same as described in previous embodiments. A protruding portion 330EA1 and a protruding portion 330EA2 of the connecting portion 330A and a protruding portion 330EB1 and a protruding portion 330EB2 of the connecting portion 330B protrude outward from opposite sides of the bottom portion 312.

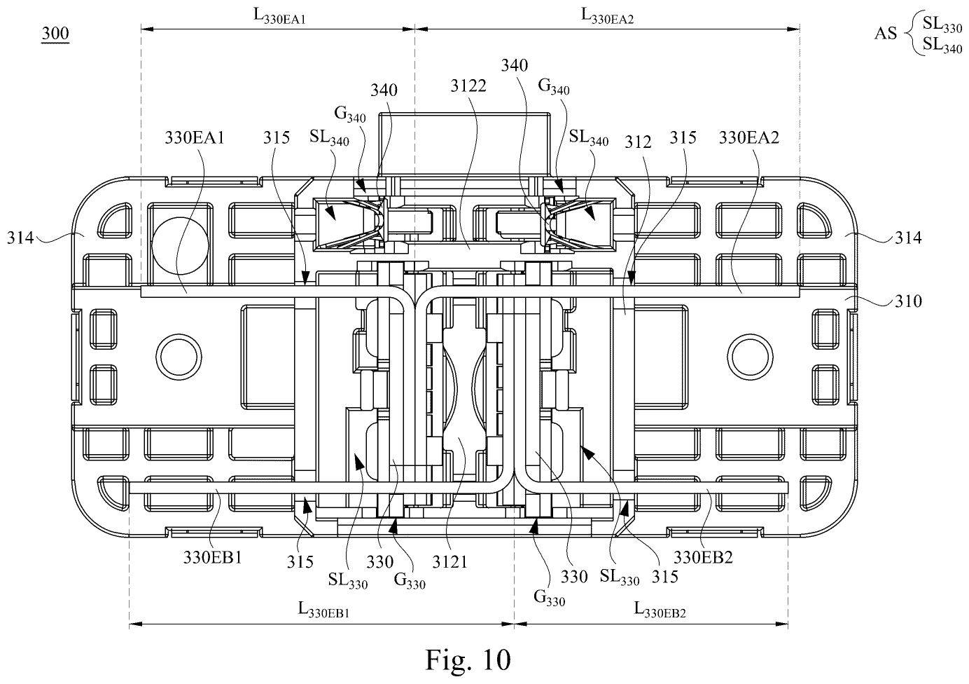

Reference is made to FIG. 10. FIG. 10 is a bottom view of the connector 300 in accordance with an embodiment of the present disclosure. A partitioning wall 3121 and a partitioning wall 3122 are interlaced in the accommodating space AS and divide the accommodating space AS into two conductive terminal channels SL₃₃₀ and two signal terminal channels SL₃₄₀. Both the partitioning wall 3121 and the partitioning wall 3122 communicate with the trench T. A guiding groove G₃₃₀ is recessed from an edge of the conductive terminal channel SL₃₃₀ and configured to guide the first conductive terminal 330 within the conductive terminal channel SL₃₃₀. A guiding groove G₃₄₀ is recessed from an edge of the signal terminal channel SL₃₄₀ and configured to guide the signal terminal 340 within the signal terminal channel SL₃₄₀. The protruding portion 330EA1, the protruding portion 330EA2, the protruding portion 330EB1, and the protruding portion 330EB2 protrude outward from the accommodating space AS. The protruding portion 330EA1 and the protruding portion 330EA2 extend away from each other, and the protruding portion 330EB1 and the protruding portion 330EB2 also extend away from each other. The protruding portion 330EA1 and the protruding portion 330EB1 extend in parallel and extend outward from the same side of the bottom portion 312 through a gap 315, and the protruding portion 330EA2 and the protruding portion 330EB2 extend in parallel and extend outward from the other side of the bottom portion 312 through a gap 315. A length L_{330EA1} of the protruding portion 330EA1 is less than a length L_{330EA2} of the protruding portion 330EA2 so that both extend the same distance from the side edge of the bottom portion 312. A length L_{330EB1} of the protruding portion 330EB1 is greater than a length L_{330EB2} of the protruding portion 330EB2 so that both extend the same distance from the side edge of the bottom portion 312.

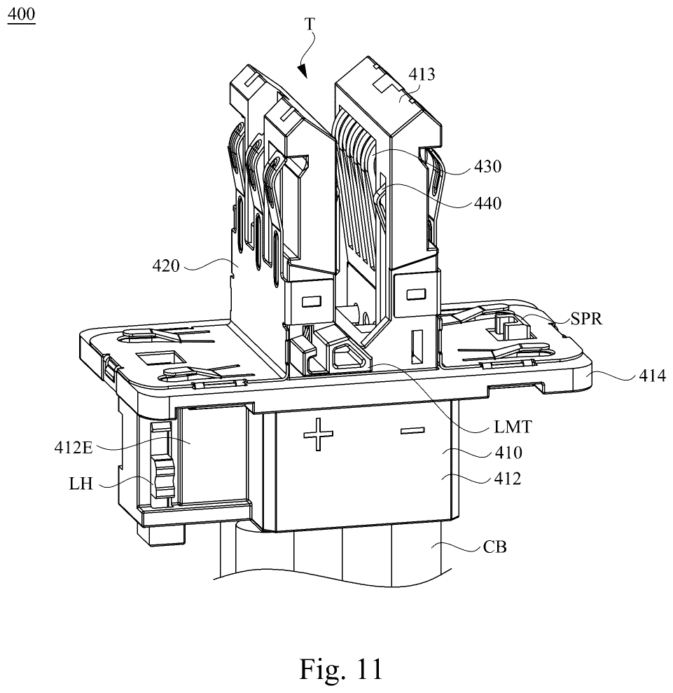

Reference is made to FIG. 11. FIG. 11 is a perspective view of a connector 400 in accordance with an embodiment of the present disclosure. The connector 400 is a vertical-exit connector configured to connect to a cable CB. Compared with the aforementioned embodiments, the connector 400 further includes a latch LH, and the housing 410 further includes an extending portion 412E, a limiting portion LMT, and a blocking portion SPR, such that the connector 400 can be locked by sliding in a locking direction when installed on a panel. The extending portion 412E is connected to one of the wing portions 414 on a surface close to the bottom portion 412. In the extending direction of the wing portion 414, a width of the extending portion 412E is greater than half the width of the wing portion 414. The aforementioned wing portion 414 includes a through hole with an opening formed on another surface. A proximal side of the wing portion 414 is connected to the upright portion 413, while a distal side of the wing portion 414 is away from the upright portion 413 (i.e., the opposite side of the proximal side). A distance between the opening and the distal side is smaller than a distance between the opening and the proximal side. In some embodiments, the extending portion 412E extends from a side surface of the bottom portion 412, and the other side of the extending portion 412E is connected to one of the wing portions 414. The blocking portion SPR is disposed on a surface of the other wing portion 414 close to the upright portion 413 and extends forward (i.e., in the same direction as the extending direction of the upright portion 413). The limiting portion LMT is disposed on one of the upright portions 413 and is separated from the two wing portions 414. The latch LH is slidably accommodated in the extending portion 412E and is configured to partially pass through the through hole of the other wing portion 414.

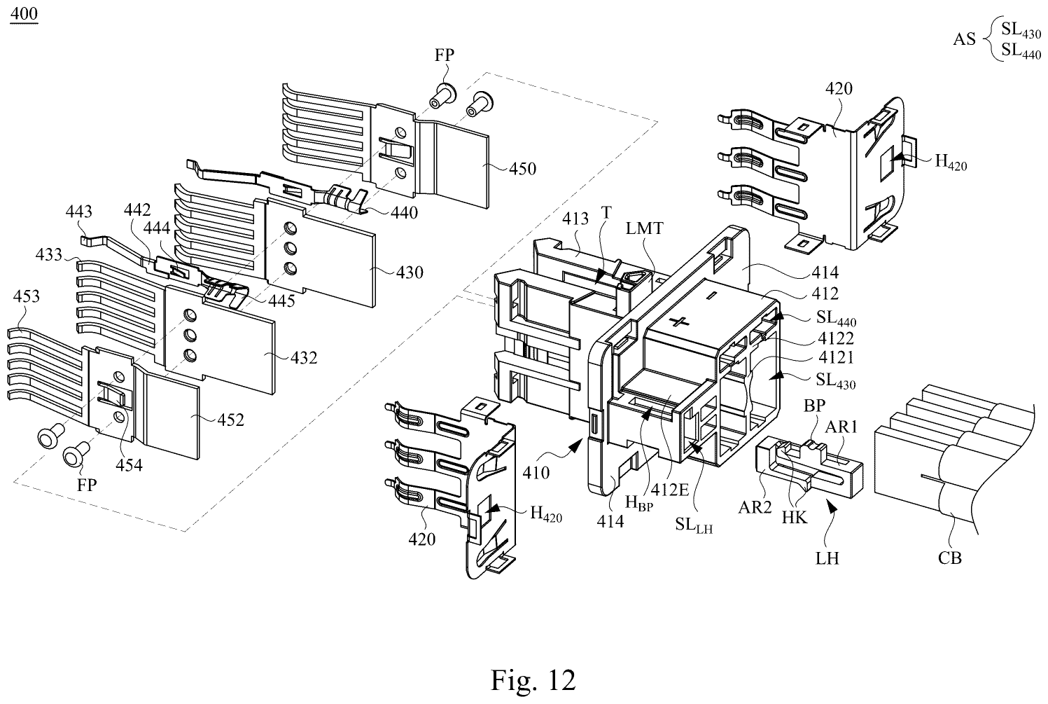

Reference is made to FIG. 12. FIG. 12 is an exploded view of the connector 400 in accordance with an embodiment of the present disclosure. A partitioning wall 4121 and a partitioning wall 4122 are interlaced in the accommodating space AS and divide the accommodating space AS into two conductive terminal channels SL₄₃₀ and two signal terminal channels SL₄₄₀, and the partitioning wall 4121 and the partitioning wall 4122 communicate with the trench T. Each of the two ground terminals 420 has a perforation H₄₂₀, one of which is aligned with the through hole of the wing portion 414. The blocking portion SPR and the latch LH are configured to respectively pass through the perforations H₄₂₀ of the two ground terminals 420. The first conductive terminal 430 includes a middle portion 432 and a plurality of contacting portions 433. The middle portion 432 is plate-shaped and electrically connected to the cable CB. The signal terminal 440 includes a middle portion 442, a contacting portion 443, a locking beam 444, and a crimping portion 445. The second conductive terminal 450 includes a middle portion 452, a plurality of contacting portions 453, and a locking beam 454. The extending portion 412E has a latch channel SL_{LH}. The latch channel SL_{LH} communicates with the through hole of the wing portion 414, and the latch LH is disposed in the latch channel SL_{LH}. The extending portion 412E further has a status hole H_{BP}. The status hole H_{BP} communicates with the latch channel SL_{LH}. The latch LH includes a first elastic arm AR1, a second elastic arm AR2, two hooks HK, and a bump BP. The first elastic arm AR1 has a fixed end and a free end. The fixed end is connected to a bottom end of the latch LH. The second elastic arm AR2 also has a fixed end and a free end. The fixed end is connected to a top end of the latch LH. The first elastic arm AR1 and the second elastic arm AR2 are located on opposite sides of the latch LH. The two hooks HK are respectively disposed on the free end of the first elastic arm AR1 and the free end of the second elastic arm AR2. The bump BP is disposed on the first elastic arm AR1. The bump BP is configured to pass through the status hole H_{BP}.

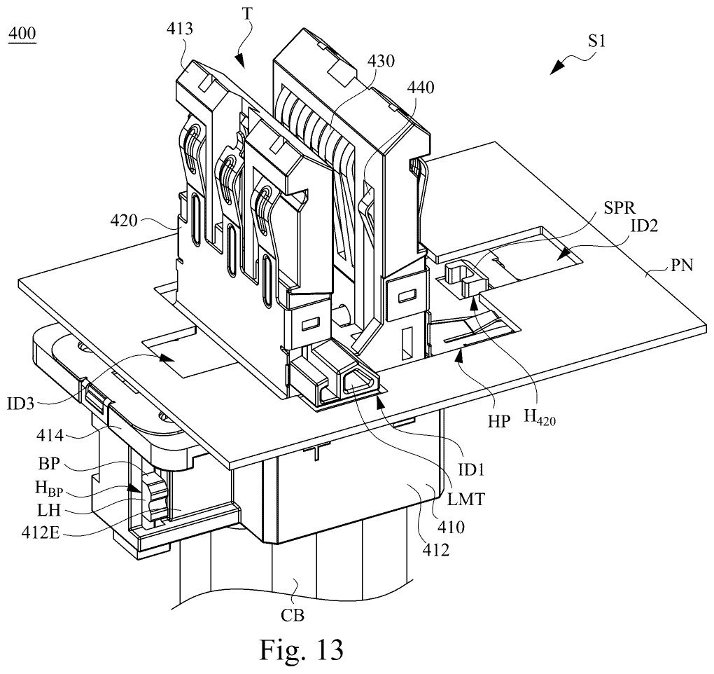

Reference is made to FIG. 13. FIG. 13 is a perspective view of the connector 400 in a first state S1 in accordance with an embodiment of the present disclosure. As shown in FIG. 13, the connector 400 can be mounted on a panel PN, which may be a chassis of a system. The panel PN has a hollowed portion HP and a first indentation ID1. The two upright portions 413 and the limiting portion LMT respectively pass through the hollowed portion HP and the first indentation ID1 of the panel PN. The panel PN further includes a second indentation ID2 and a third indentation ID3. The first indentation ID1, the second indentation ID2, and the third indentation ID3 communicate with the hollowed portion HP and are recessed from the hollowed portion HP toward a periphery of the panel PN. The second indentation ID2 and the third indentation ID3 are located opposite to each other. A recess depth of the second indentation ID2 is greater than a recess depth of the third indentation ID3, i.e., a width of the second indentation ID2 in the sliding locking direction is greater than a width of the third indentation ID3.

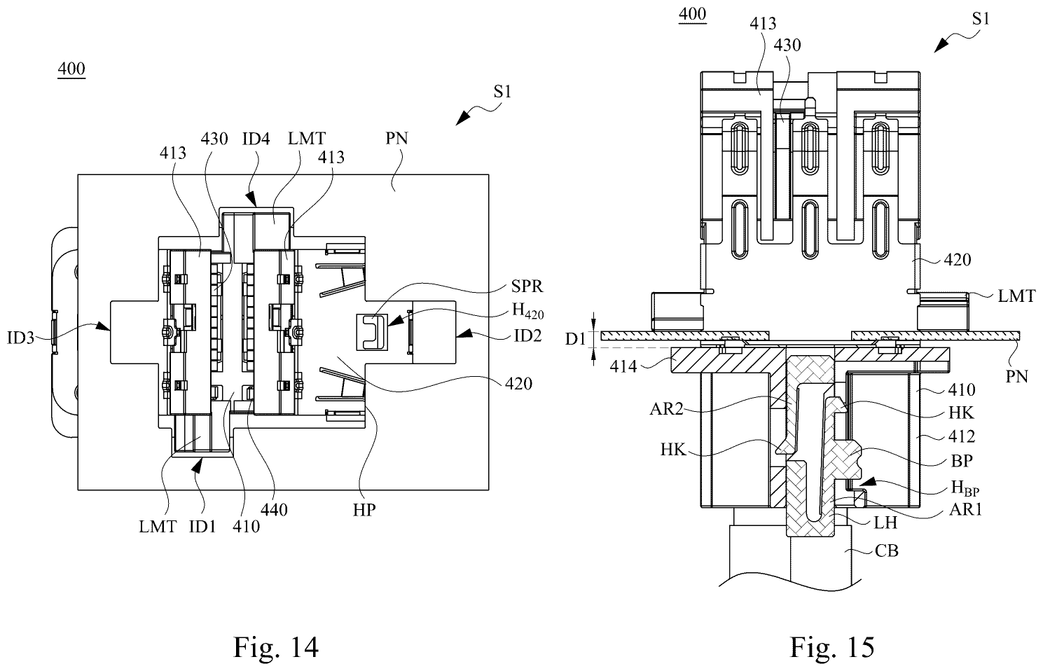

Reference is made to FIG. 14. FIG. 14 is a top view of the connector 400 in the first state S1 in accordance with an embodiment of the present disclosure. As shown in FIG. 14, the panel PN further includes a fourth indentation ID4. The fourth indentation ID4 is located opposite to the first indentation ID1. The fourth indentation ID4 also communicates with the hollowed portion HP and is recessed from the hollowed portion HP toward the periphery of the panel PN. The first indentation ID1 and the fourth indentation ID4 correspond to the two limiting portions LMT of the housing 410. The widths of the two limiting portions LMT in the sliding locking direction may differ, and the widths of the first indentation ID1 and the fourth indentation ID4 in the sliding locking direction may also differ to achieve fool-proofing. As shown in FIG. 14, when the connector 400 is in the first state S1, the two limiting portions LMT are respectively aligned with the first indentation ID1 and the fourth indentation ID4, and the panel PN covers at least one part of the perforations H₄₂₀ of the ground terminals 420.

Reference is made to FIG. 15. FIG. 15 is a sided view of the connector 400 in the first state S1 in accordance with an embodiment of the present disclosure. As shown in FIG. 15, in this embodiment, the panel PN is located between the limiting portion LMT and the wing portion 414. The limiting portion LMT and the wing portion 414 are separated by a distance D1, and the distance D1 is greater than or equal to a thickness of the panel PN. When the connector 400 is in the first state S1, the latch LH does not pass through the panel PN. The bump BP passes through the status hole H_{BP} and is movable relative to the status hole H_{BP}.

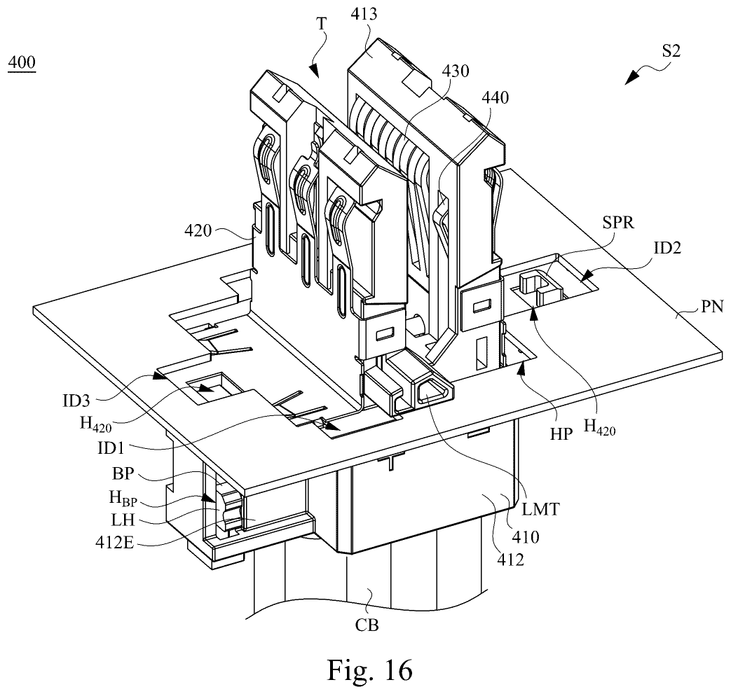

Reference is made to FIG. 16. FIG. 16 is a perspective view of the connector 400 in a second state S2 in accordance with an embodiment of the present disclosure. When the connector 400 transitions from the first state S1 to the second state S2, the housing 410 and the panel PN move relative to each other in a lateral direction (i.e., the sliding locking direction) until the third indentation ID3 is exposed to reveal the perforation H₄₂₀ of the ground terminal 420.

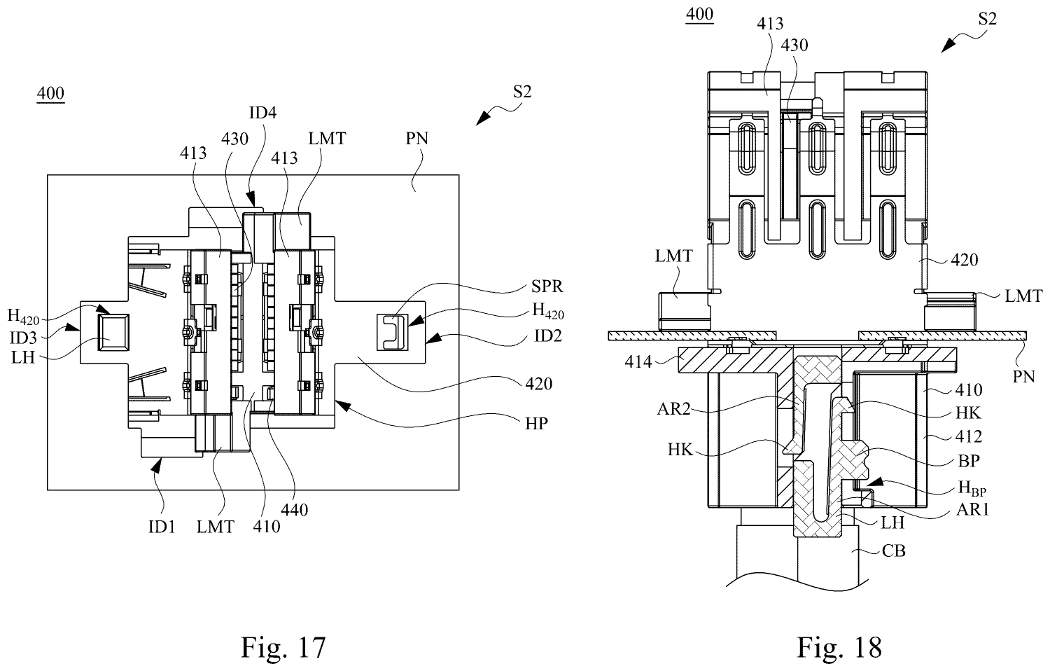

Reference is made to FIG. 17. FIG. 17 is a top view of the connector 400 in the second state S2 in accordance with an embodiment of the present disclosure. When the connector 400 is in the second state S2, the two limiting portions LMT are respectively staggered from the first indentation ID1 and the fourth indentation ID4, and the latch LH is exposed relative to the third indentation ID3. The perforation H₄₂₀ of the ground terminal 420 is located within a range of the third indentation ID3.

Reference is made to FIG. 18. FIG. 18 is a sided view of the connector 400 in the second state S2 in accordance with an embodiment of the present disclosure. As shown in FIG. 18, the panel PN is still located between the limiting portion LMT and the wing portion 414. In the sided view, when the connector 400 is in the second state S2, the latch LH still does not pass through the panel PN.

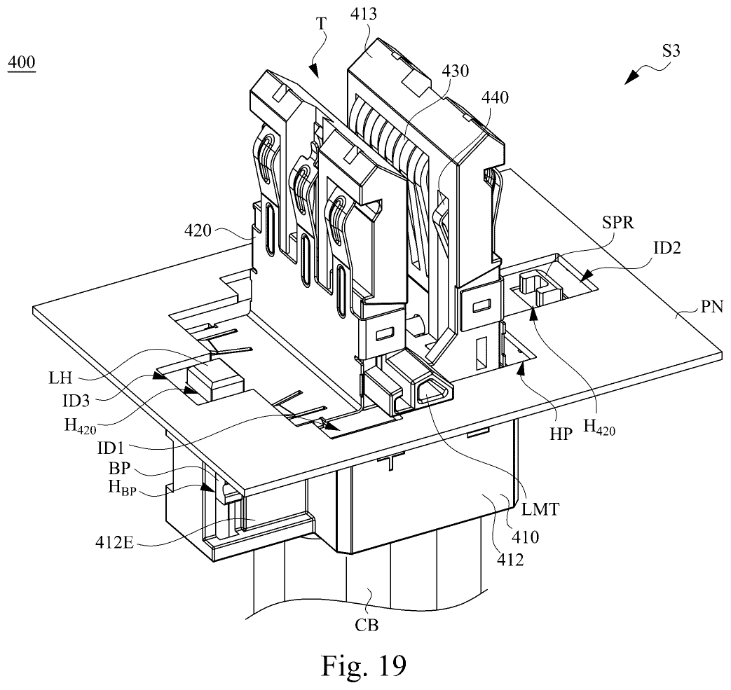

Reference is made to FIG. 19. FIG. 19 is a perspective view of the connector 400 in a third state S3 in accordance with an embodiment of the present disclosure. As shown in FIG. 19, when the connector 400 transitions from the second state S2 to the third state S3, the latch LH moves in a longitudinal direction relative to the extending portion 412E. The latch LH simultaneously passes through the perforation H₄₂₀ of the ground terminal 420 and the wing portion 414. In this case, since the blocking portion SPR is located within a range of the second indentation ID2 and the latch LH passes through the panel PN and is within the range of the third indentation ID3, the panel PN and the housing 410 can be appropriately limited in the lateral direction.

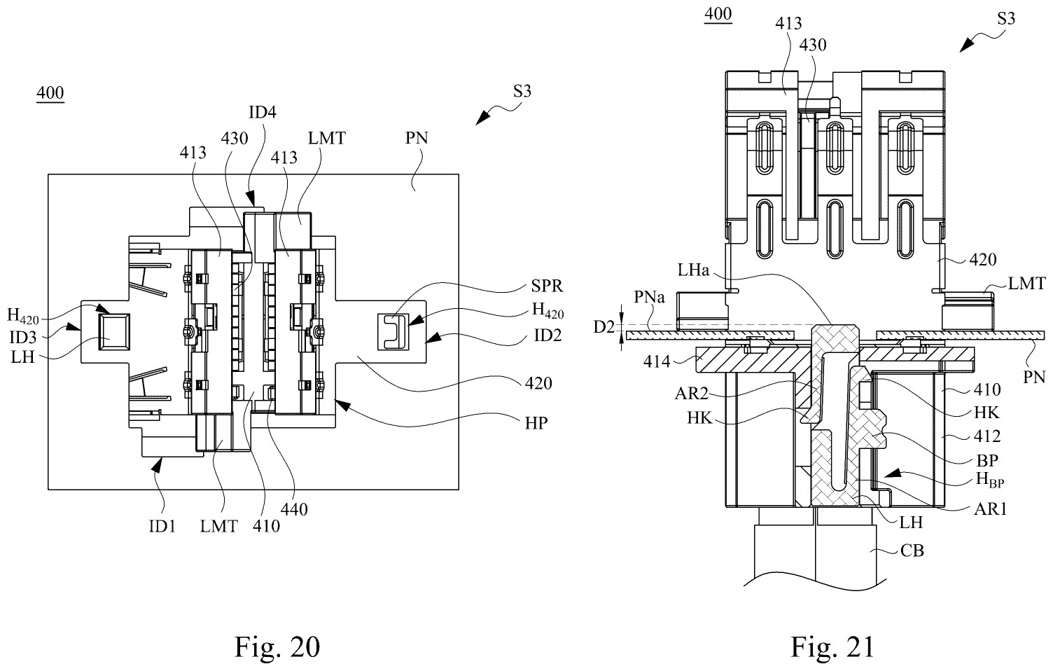

Reference is made to FIG. 20. FIG. 20 is a top view of the connector 400 in the third state S3 in accordance with an embodiment of the present disclosure. When the connector 400 is in the third state S3, the two limiting portions LMT remain staggered from the first indentation ID1 and the fourth indentation ID4. The blocking portion SPR remains exposed relative to the second indentation ID2, and the latch LH remains exposed relative to the third indentation ID3.

Reference is made to FIG. 21. FIG. 21 is a sided view of the connector 400 in the third state S3 in accordance with an embodiment of the present disclosure. When the connector 400 is in the third state S3, the latch LH simultaneously passes through the wing portion 414, the ground terminal 420, and the panel PN. Specifically, the latch LH has a top surface LHa, and the panel PN has a top surface PNa. The top surface LHa of the latch LH is higher than the top surface PNa of the panel PN by a distance D2.

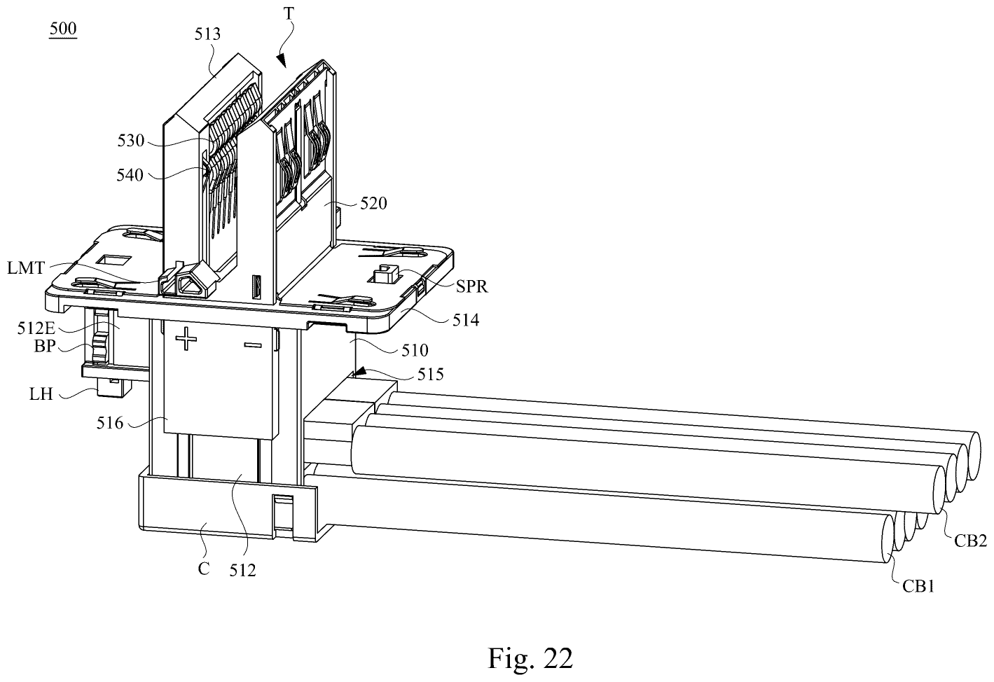

Reference is made to FIG. 22. FIG. 22 is a perspective view of a connector 500 in accordance with an embodiment of the present disclosure. The connector 500 is configured to be connected to a first cable CB1 and a second cable CB2. The connector 500 includes a housing 510, a ground terminal 520, a conductive terminal 530, and a signal terminal 540. The housing 510 includes a bottom portion 512, two upright portions 513, and two wing portions 514. Compared to the connector 400, the connector 500 is a side-exit connector. The following description focuses on the differences. The housing 510 includes an extending portion 512E, an opening 515, and an extending housing 516. The extending portion 512E is located on a side surface of the bottom portion 512, and the opening 515 is located on the opposite side surface of the bottom portion 512. The first cable CB1 and the second cable CB2 are electrically connected to the conductive terminal 530 at a position adjacent to the opening 515. The first cable CB1 and the second cable CB2 extend in parallel along a lateral direction. The extending housing 516 extends from another side surface of the bottom portion 512 and is configured to accommodate a portion of the signal terminal 540.

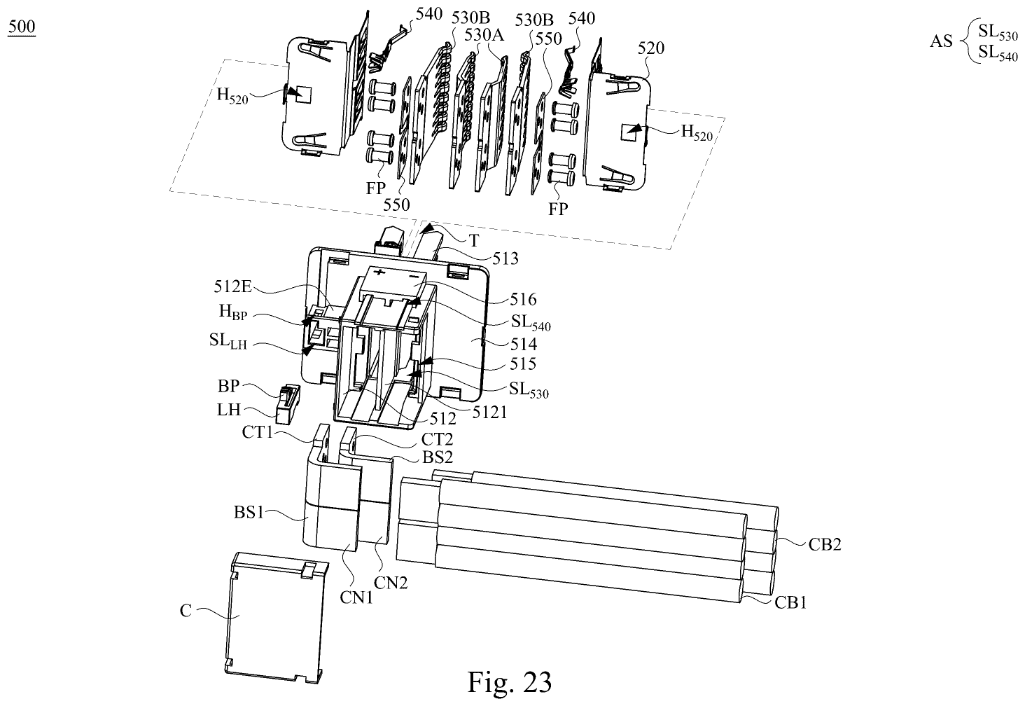

Reference is made to FIG. 23. FIG. 23 is an exploded view of the connector 500 in accordance with an embodiment of the present disclosure. As shown in FIG. 23, in this embodiment, the partitioning wall 5121 divides the accommodating space AS into two conductive terminal channels SL₅₃₀, and the partitioning wall 5121 communicates with the trench T. The extending housing 516 and the opposite side surface of the bottom portion 512 jointly define a signal terminal channel SL₅₄₀. The conductive terminal 530 includes two first conductive terminals 530A, two second conductive terminals 530B, a first connecting plate BS1, a second connecting plate BS2, and a plurality of fixing portions FP. The first conductive terminal set includes one of the first conductive terminals 530A, one of the second conductive terminals 530B, and the first connecting plate BS1. The second conductive terminal set includes the other one of the first conductive terminal 530A, the other one of the second conductive terminal 530B, and the second connecting plate BS2. The first conductive terminal set and the second conductive terminal set are electrically isolated and not in contact with each other. A locking part 550 is used to abut against an inner surface of the housing 510. Each of the two ground terminals 520 has a perforation H₅₂₀. The first connecting plate BS1 includes a first portion CT1 and a second portion CN1. The second portion CN1 is bent from the first portion CT1. The second connecting plate BS2 includes a first portion CT2 and a second portion CN2. The second portion CN2 is bent from the first portion CT2. The first portion CT1 and the first portion CT2 extend in a first direction (e.g., longitudinally), and the second portion CN1 and the second portion CN2 extend in a second direction (e.g., laterally). The first conductive terminal set is accommodated in one of the conductive terminal channels SL₅₃₀, and the second conductive terminal set is accommodated in the other one of the conductive terminal channel SL₅₃₀.

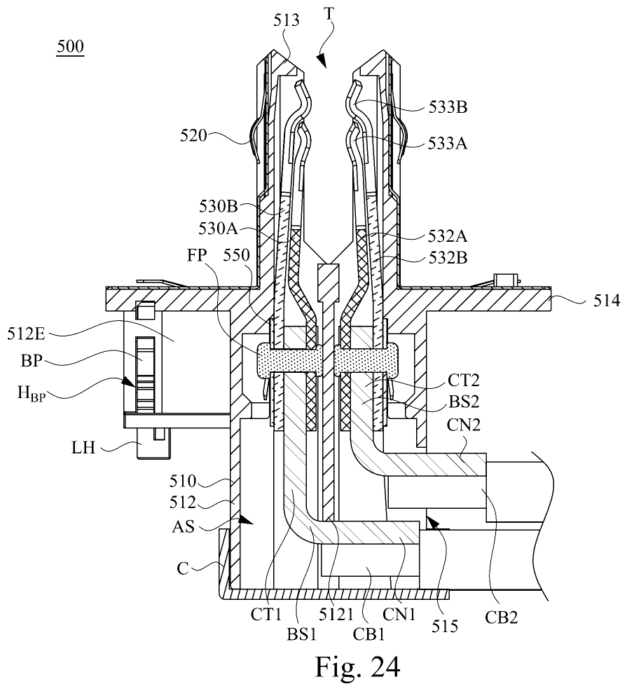

Reference is made to FIG. 24. FIG. 24 is a cross-sectional view of the connector 500 in accordance with an embodiment of the present disclosure. The first conductive terminal 530A includes a middle portion 532A and a contacting portion 533A. The second conductive terminal 530B includes a middle portion 532B and a contacting portion 533B. The contacting portion 533A and the contacting portion 533B are staggered in a direction (e.g., a longitudinal direction). The first portion CT1 and the first portion CT2 are respectively disposed between the middle portion 532A and the middle portion 532B of the first conductive terminal set and the middle portion 532A and the middle portion 532B of the second conductive terminal set, and the first portion CT1 and the first portion CT2 are fixed by the fixing portions FP. The first connecting plate BS1 and the second connecting plate BS2 protrude from the accommodating space AS toward the opening 515 and are respectively connected to the first cable CB1 and the second cable CB2. The second portion CN1 of the first connecting plate BS1 and the second portion CN2 of the second connecting plate BS2 are exposed relative to the opening 515.

From the above detailed description of the specific embodiments of the present disclosure, it can be clearly seen that in the connector of the present disclosure, since each of the first conductive terminal set and the second conductive terminal set includes a locking beam abutting against a blocking surface, the first conductive terminal set and the second conductive terminal set can be positioned on the housing when assembled into the housing. In the connector of the present disclosure, since the conductive terminal includes a crimping portion bent along a rotation axis, the crimping portion of the conductive terminal can tightly bind the cable, thereby ensuring that the cable is in reliable contact with the conductive terminal. In the connector of the present disclosure, since the locking part of each of the first conductive terminal set and the second conductive terminal set includes a raised portion protruding from a middle portion, when the first conductive terminal set and the second conductive terminal set are assembled into the housing, the first conductive terminal set and the second conductive terminal set can be separated from the two upright portions of the housing by a distance to form a void, thereby enhancing the heat dissipation efficiency of the connector. In the connector and the housing of the present disclosure, since the connector includes a panel disposed on the housing, the panel has a hollowed portion through which the two upright portions pass, and the connector further includes a latch passing through a wing portion and a blocking portion disposed on the wing portion, the housing can be appropriately limited in the lateral direction relative to the panel, thereby preventing the housing from detaching from the panel. In the connector and the housing of the present disclosure, since the panel covers the latch and the perforation of the ground terminal when the limiting portion is aligned with the first indentation, and the latch is exposed relative to the third indentation when the limiting portion is staggered from the first indentation, the housing can enter the hollowed portion of the panel, and the housing can be appropriately limited in the longitudinal direction relative to the panel through the special structure of the panel, thereby preventing the housing from detaching from the panel. In the connector and the housing of the present disclosure, since the first connecting plate and the second connecting plate pass through the opening, and the portion of the first connecting plate and the portion of the second connecting plate extending beyond of the bottom portion of the housing spaced by a distance (i.e., staggered), a place where the cable and the portion of the first connecting plate connect and a place where the cable and the portion of the second connecting plate connect can be staggered, thereby reducing spatial interference between cables and saving occupied space. Overall, the connector and the housing of the present disclosure provides structural stability to the overall connector.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A connector, comprising:
a housing, comprising:
a bottom portion having an accommodating space;
two upright portions extending in parallel from the bottom portion in an extending direction, the two upright portions jointly defining a trench;
two wing portions respectively extending away from each other in a direction away from the two upright portions and extending beyond a side surface of the bottom portion;
a limiting portion disposed on one of the two upright portions and separated from the two wing portions;
an extending portion extending from a side surface of the bottom portion and connected to one of the two wing portions, the extending portion having a latch channel, the one of the two wing portions having a through hole communicating with the latch channel; and
a latch slidably accommodated in the latch channel and configured to partially pass through the through hole; and
a first conductive terminal set and a second conductive terminal set accommodated in the accommodating space of the housing and respectively extending adjacent to the two upright portions.

2. The connector of claim 1, wherein each of the first conductive terminal set and the second conductive terminal set comprises a first conductive terminal, a second conductive terminal, and a fixing portion, the first conductive terminal and the second conductive terminal are sequentially arranged in a direction and each comprise a middle portion and a plurality of contacting portions, the contacting portions extend from an end of the middle portion into the trench, and the fixing portion secures the middle portion of the first conductive terminal and the middle portion of the second conductive terminal.

3. The connector of claim 2, wherein the contacting portions of the first conductive terminal and the contacting portions of the second conductive terminal are alternately arranged in a direction.

4. The connector of claim 2, wherein each of the first conductive terminal set and the second conductive terminal set further comprises a third conductive terminal, the third conductive terminal of the first conductive terminal set comprises a first protruding portion protruding outward from the accommodating space, the third conductive terminal of the second conductive terminal set comprises a second protruding portion protruding outward from the accommodating space, the first protruding portion and the second protruding portion are plate-shaped and extend in parallel, and a length of the first protruding portion is less than a length of the second protruding portion.

5. The connector of claim 4, wherein the bottom portion further comprises a plurality of gaps located on the side surface of the bottom portion, and the first protruding portion and the second protruding portion respectively pass through the gaps.

6. The connector of claim 4, further comprising a cover body covering a side of the bottom portion away from the two upright portions, wherein the cover body comprises a plurality of supporting ribs and a slit defined between the supporting ribs, a portion of the third conductive terminal is accommodated in the slit, and the first conductive terminal abuts against the supporting ribs.

7. The connector of claim 2, wherein each of the first conductive terminal set and the second conductive terminal set further comprises a third conductive terminal, the third conductive terminal of the first conductive terminal set comprises a first protruding portion and a second protruding portion protruding outward from the accommodating space and extending away from each other, and the third conductive terminal of the second conductive terminal set comprises a third protruding portion and a fourth protruding portion protruding outward from the accommodating space and extending away from each other, wherein the first protruding portion and the third protruding portion are plate-shaped and extend in parallel, and the second protruding portion and the fourth protruding portion are plate-shaped and extend in parallel.

8. The connector of claim 7, wherein both the first protruding portion and the second protruding portion and both the third protruding portion and the fourth protruding portion are respectively located on opposite sides of the accommodating space.

9. The connector of claim 1, further comprising two ground terminals, wherein one of the two ground terminals has a perforation, and the perforation is aligned with the through hole of the two wing portions.

10. The connector of claim 1, wherein the other one of the two wing portions comprises a blocking portion on a surface close to the two upright portions, and the blocking portion extends along the extending direction.

11. The connector of claim 1, wherein the latch further comprises:
a first elastic arm having a fixed end connected to a bottom end of the latch and a free end;
a second elastic arm having a fixed end connected to a top end of the latch and a free end, and the first elastic arm and the second elastic arm being located on opposite sides of the latch;
a first hook and a second hook respectively disposed on the free end of the first elastic arm and the free end of the second elastic arm; and
a bump disposed on the first elastic arm.

12. The connector of claim 11, wherein the extending portion further has a status hole communicating with the latch channel, and the bump passes through the status hole and is movable relative to the status hole.

13. A housing, comprising:
a bottom portion having an accommodating space;
two upright portions extending in parallel from the bottom portion in an extending direction, the two upright portions jointly defining a trench;
two wing portions respectively extending away from each other in a direction away from the two upright portions and extending beyond a side surface of the bottom portion;
a limiting portion disposed on one of the two upright portions and separated from the two wing portions;
an extending portion extending from the side surface of the bottom portion and connected to one of the two wing portions, the extending portion having a latch channel, the one of the two wing portions having a through hole communicating with the latch channel; and
a latch slidably accommodated in the latch channel and configured to partially pass through the through hole.

14. The housing of claim 13, wherein the bottom portion further comprises a plurality of gaps located on the side surface of the bottom portion.

15. The housing of claim 13, further comprising a cover body covering a side of the bottom portion away from the two upright portions, wherein the cover body comprises a plurality of supporting ribs and a slit defined between the supporting ribs.

16. The housing of claim 13, wherein the other one of the two wing portions comprises a blocking portion on a surface close to the two upright portions, and the blocking portion extends along the extending direction.

17. The housing of claim 13, wherein the latch further comprises:
a first elastic arm having a fixed end connected to a bottom end of the latch and a free end;
a second elastic arm having a fixed end connected to a top end of the latch and a free end, and the first elastic arm and the second elastic arm being located on opposite sides of the latch;
a first hook and a second hook respectively disposed on the free end of the first elastic arm and the free end of the second elastic arm; and
a bump disposed on the first elastic arm.

18. The housing of claim 17, wherein the extending portion further has a status hole communicating with the latch channel, and the bump passes through the status hole and is movable relative to the status hole.

19. The housing of claim 13, wherein the bottom portion further comprises a plurality of partitioning walls, the partitioning walls are interlaced in the accommodating space and divide the accommodating space into two conductive terminal channels and two signal terminal channels, and the partitioning walls communicate with the trench.

20. The housing of claim 13, wherein the limiting portion and the one of the two wing portions are separated by a distance.
